(19) United States
(12) Patent Application Publication
(10) Pub. No.: US 2013/0027757 A1
(43) Pub. Date: Jan. 31, 2013

(54) MOBILE FAX MACHINE WITH IMAGE STITCHING AND DEGRADATION REMOVAL PROCESSING

(71) Applicants: Te-Won Lee, Seoul (KR); Kyuwoong Hwang, Daejeon (KR); Kisun You, Suwon (KR); Taesu Kim, Seoul (KR); Hyung-Il Koo, Seoul (KR)

(72) Inventors: Te-Won Lee, Seoul (KR); Kyuwoong Hwang, Daejeon (KR); Kisun You, Suwon (KR); Taesu Kim, Seoul (KR); Hyung-Il Koo, Seoul (KR)

(73) Assignee: QUALCOMM INCORPORATED, San Diego, CA (US)

(21) Appl. No.: 13/194,872

(22) Filed: Jul. 29, 2011

(51) Int. Cl. H04N 1/387

(52) U.S. Cl. 358/450

(57) ABSTRACT

A method of scanning an image of a document with a portable electronic device includes interactively indicating in substantially real time on a user interface of the portable electronic device, an instruction for capturing at least one portion of an image to enhance quality. The indication is in response to identifying degradation associated with the portion(s) of the image. The method also includes capturing the portion(s) of the image with the portable electronic device according to the instruction. The method further includes stitching the captured portion(s) of the image in place of a degraded portion of a reference image corresponding to the document, to create a corrected stitched image of the document.

### TECHNICAL FIELD

The present disclosure relates, in general, to mobile devices, and, more particularly, to mobile device image processing methods and systems.

### BACKGROUND

When sending a copy of printed material, flatbed scanners or facsimiles are generally used. These flatbed scanners or facsimiles are cumbersome to use, making it better to take a picture and sending the image using portable computing or image devices.

Advances in technology have resulted in smaller and more powerful computing devices. For example, there currently exist a variety of portable personal computing devices or portable electronic devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Such wireless telephones can process executable instructions, including software applications, such as a web browser application, that can be used to access the Internet. As such, these wireless telephones can include significant computing capabilities.

Digital signal processors (DSPs), image processors, and other processing devices are frequently used in portable personal computing devices that include digital cameras, or that display image or video data captured by a digital camera. Such processing devices can be utilized to provide video and audio functions, to process received data such as captured image data, or to perform other functions.

However, camera-captured documents may suffer from degradations caused by non-planar document shape and perspective projection, which lead to poor quality images.

### SUMMARY

According to some aspects of the disclosure, a method of scanning an image of a document with a portable electronic device includes interactively indicating in substantially real time on a user interface of the portable electronic device, an instruction for capturing at least one portion of an image to enhance quality. The indication may be in response to identifying degradation associated with the portion(s) of the image. The method may also include capturing the portion(s) of the image with the portable electronic device according to the instruction. The method may further include stitching the captured portion(s) of the image in place of a degraded portion of a reference image corresponding to the document, to create a corrected stitched image of the document.

According to some aspects of the disclosure, an apparatus for scanning an image of a document with a portable electronic device includes means for interactively indicating in substantially real time on a user interface of the portable electronic device, an instruction for capturing at least one portion of an image to enhance quality. The indication may be in response to identifying degradation associated with the portion(s) of the image. The apparatus may also include means for capturing the portion(s) of the image with the portable electronic device according to the instruction. The apparatus may further include means for stitching the captured portion(s) of the image in place of a degraded portion of a reference image corresponding to the document, to create a corrected stitched image of the document.

According to some aspects of the disclosure, an apparatus for scanning an image of a document with a portable electronic device includes a memory and at least one processor coupled to the memory. The processor(s) is configured to interactively indicate in substantially real time on a user interface of the portable electronic device, an instruction for capturing at least one portion of an image to enhance quality. The indication may be in response to identifying degradation associated with the portion(s) of the image. The processor(s) is further configured to capture the portion(s) of the image with the portable electronic device according to the instruction. The processor(s) may also be configured to stitch the captured portion(s) of the image in place of a degraded portion of a reference image corresponding to the document, to create a corrected stitched image of the document.

According to some aspects of the disclosure, a computer program product for scanning an image of a document with a portable electronic device includes a computer-readable medium having non-transitory program code recorded thereon. The program code includes program code to interactively indicate in substantially real time on a user interface of the portable electronic device, an instruction for capturing at least one portion of an image to enhance quality. The indication may be in response to identifying degradation associated with the portion(s) of the image. The program code also includes program code to capture the portion(s) of the image with the portable electronic device according to the instruction. The program code further includes program code to stitch the captured portion(s) of the image in place of a degraded portion of a reference image corresponding to the document, to create a corrected stitched image of the document.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present teachings, reference is now made to the following description taken in conjunction with the accompanying drawings.

FIG. 1 is a block diagram illustrating an exemplary portable electronic device according to some aspects of the disclosure.

FIG. 2 illustrates an image of a document captured by an imaging device.

FIG. 3 illustrates an exemplary block diagram of the image processor of FIG. 1 according to some aspects of the disclosure.

FIG. 4 is an exemplary image illustrating radial and vignetting distortions.

FIG. 5 shows an exemplary image of a captured document illustrating boundaries and corners of the document according to some aspects of the disclosure.

FIG. 6A is an exemplary illustration of a captured image showing perspective distortion.

FIG. 6B illustrates a captured image after perspective rectification.

FIGS. 7A, 7B and 7C illustrate an exemplary interactive process for reducing, rectifying or correcting perspective distortion interactively with a user according to some aspects of the disclosure.

FIG. 8 illustrates an exemplary image of the captured document showing photometric distortions.

FIG. 9 illustrates an exemplary image with an instruction or indication to a user previewing the image.

FIG. 10 illustrates an exemplary flowchart of a portable electronic device image acquisition method.

FIG. 11 illustrates a flow chart of the interactive resolution enhancement process implemented at block 1006 of FIG. 10.

FIG. 12 illustrates a method of processing a captured image on a portable electronic device according to an aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The portable electronic device described herein may be any electronics device used for communication, computing, networking, and other applications. For example, the portable electronic device may be a wireless device that such as a cellular phone, a personal digital assistant (PDA), or some other device used for wireless communication.

The portable electronic device described herein may be used for various wireless communication systems such as a code division multiple access (CDMA) system, a time division multiple access (TDMA) system, a frequency division multiple access (FDMA) system, an orthogonal frequency division multiple access (OFDMA) system, an orthogonal frequency division multiplexing (OFDM) system, a single-carrier frequency division multiple access (SC-FDMA) system, and other systems that transmit modulated data. A CDMA system may implement one or more radio access technologies such as cdma2000, Wideband-CDMA (W-CDMA), and so on. cdma2000 covers IS-95, IS-2000, and IS-856 standards. A TDMA system may implement Global System for Mobile Communications (GSM). GSM and W-CDMA are described in documents from a consortium named “3rd Generation Partnership Project” (3GPP). ocdma2000 is described in documents from a consortium named “3rd Generation Partnership Project 2” (3GPP2). 3GPP and 3GPP2 documents are publicly available. An OFDMA system utilizes OFDM. An OFDM-based system transmits modulation symbols in the frequency domain whereas an SC-FDMA system transmits modulation symbols in the time domain. For clarity, much of the description below is for a wireless device (e.g., cellular phone) in a CDMA system, which may implement cdma2000 or W-CDMA. The wireless device may also be able to receive and process GPS signals from GPS satellites.

In addition, an OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies.

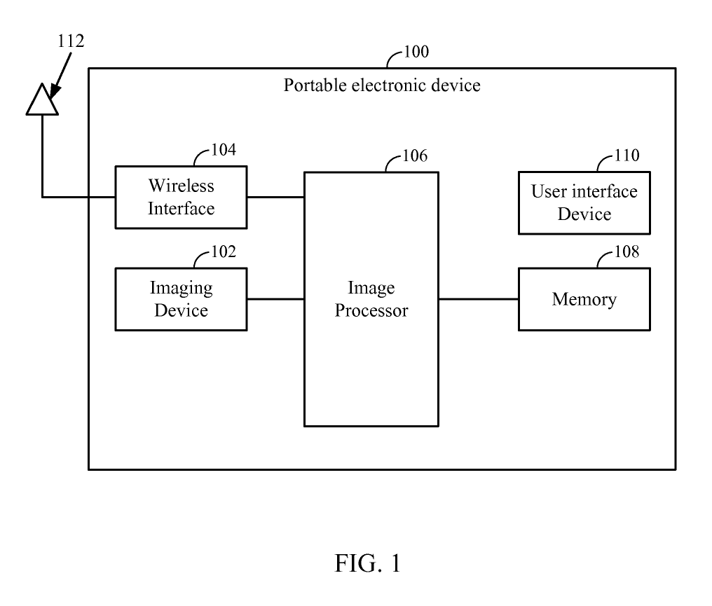

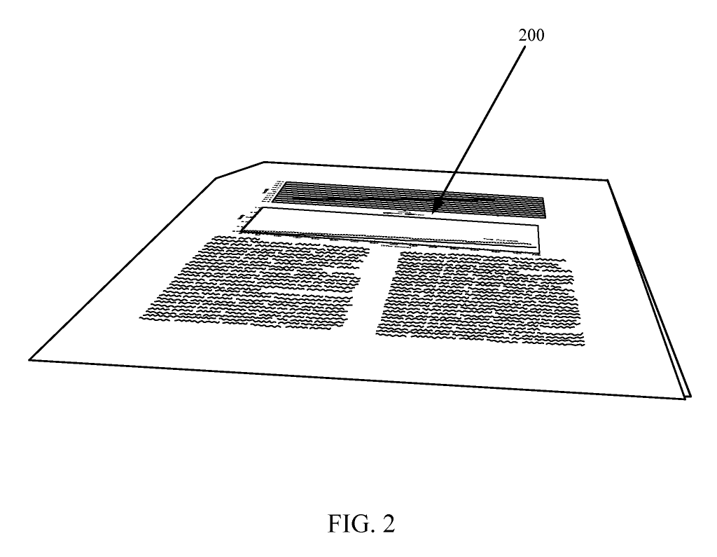

FIG. 1 is a block diagram illustrating an exemplary portable electronic device 100 according to some aspects of the disclosure. The imaging device 102, for example, a camera, can be configured to capture an image, for example, of a text document 200 (FIG. 2). The image can be captured by moving a phone over a document and taking multiple shots of the document. In some implementations, the imaging device 102 can be easily integrated with portable electronic devices such as personal digital assistants (PDAs), cell phones, media players, handheld devices or the like. The imaging device 102 can be a video camera or a still-shot camera. In some aspects of the disclosure, the portable electronic device can be a traditional camera.

The imaging device 102 transmits the captured image to the image processor 106. The image processor may then execute an application process to the captured image. Alternatively, the application process can be implemented remotely on a device that may be coupled to the portable electronic device via a network such as a local area network, a wide area network, the internet or the like. In some aspects, portions of the application process may be implemented in the portable electronic device 100 while another portion may be implemented remotely. The image processor may also be configured to stitch the multiple images taken by the imaging device 102 in to one fax page, for example. The processed image may be stored in memory 108 or can be transmitted through a network via a wireless interface 104 and antenna 112. The portable electronic device 100 may also include a user interface device 110 configured to display the captured image to the user. In some aspects, the image may be displayed as a preview image prior to saving the image in the memory 108 or prior to transmitting the image over a network.

The captured image, may suffer from degradations due to, for example, a deviation from rectilinear projection and vignetting, resulting from stitching the image together, as well as other processes. A deviation from rectilinear projection may occur when projections of straight lines in the scene do not remain straight and may introduce misalignment between images. This type of deviation may be referred to as radial distortion. Vignetting is a reduction of an image's brightness at the periphery compared to the center of the image. In addition, the captured image may suffer from perspective distortions, geometric distortions and photometric distortions. The perspective distortion of a planar surface can be understood as a projective transformation of a planar surface. A projective transformation can be a generalized linear transformation (e.g., homography) defined in a homogeneous coordinate system. Geometric distortion can arise when a three dimensional object is projected on a plane. A number of factors including lens distortions and other distortions in the mechanical, optical and electrical components of an imaging device or system may cause geometric distortions. For explanatory purposes, the perspective distortions and geometric distortions may be collectively referred to as geometric distortions and the related features and corrected images may also be referred to as geometric features or geometrically corrected images. Photometric distortions may be due to lens aberrations of the imaging device 102, for example.

It is therefore desirable to convert a captured image suffering from these degradations into a scan-like image, for example, with enhanced quality.

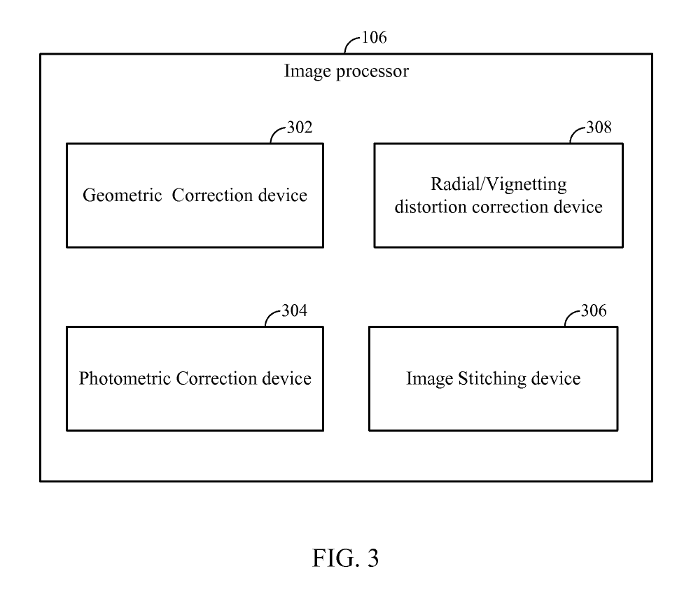

FIG. 3 illustrates an exemplary block diagram of the image processor 106 of FIG. 1 for enhancing quality of a captured image. The image processor 106 may include a geometric correction device 302, a photometric correction device 304, a radial/vignetting distortion correction device 308 and an image stitching device 306. The image processor 106 may be configured to receive a captured image from an imaging device 102, for example.

The radial/vignetting distortion correction device 308 may be configured to reduce radial and vignetting distortions. In some aspects of the disclosure, the radial/vignetting distortion correction device 308 can reduce or rectify the distortion by identifying or detecting the degradations on the image of the document 200 and initiating correction or rectification of the degraded portions of the image based on an intuitive or interactive image enhancement method, scheme or implementation discussed herein. Accordingly, the intuitive image enhancement process may be implemented in conjunction with the radial/vignetting distortion correction device 308 to enhance quality of the image of the document 200.

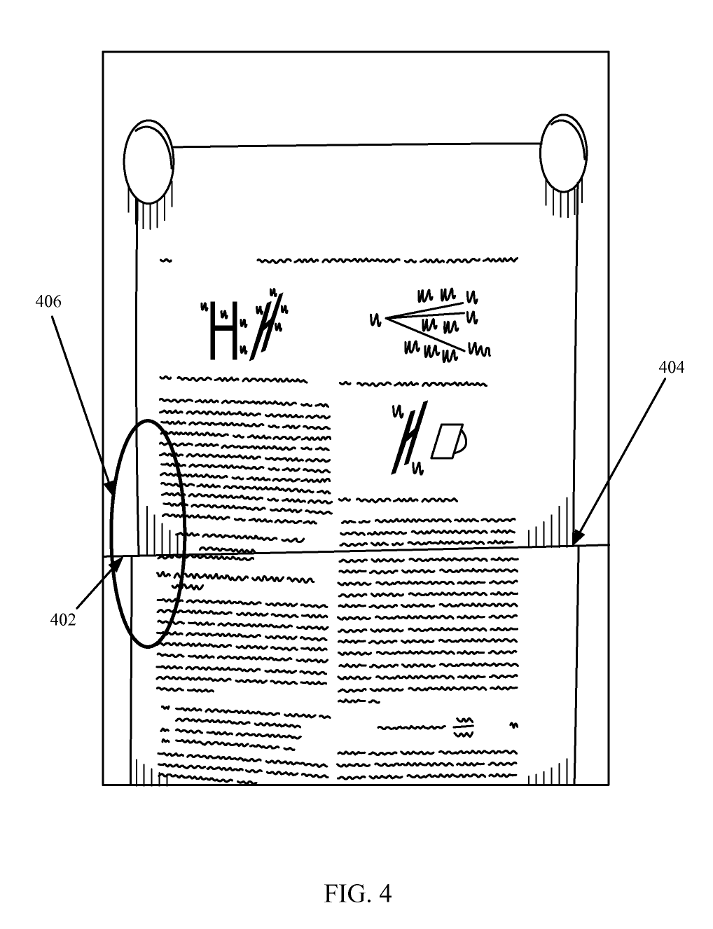

The radial/vignetting distortion correction device 308 may be configured to reduce distortions caused by a deviation from rectilinear projections in which straight lines of an image introduce misalignment between images as illustrated in FIG. 4. In FIG. 4, points 402 and 404 in the image appear to be moved from their correct position away for an optical axis of the image. The radial/vignetting distortion correction device 308 may also be configured to reduce or rectify vignetting distortions in which there is a reduction of an image's brightness at the periphery compared to the images center as illustrated in the area 406 of FIG. 4.

The geometric correction device 302 may be configured to reduce distortions such as perspective distortions, geometric distortions or other non optical or non photometric distortions. In some aspects of the disclosure, the geometric correction device 302 can reduce or rectify the distortion by identifying or detecting the distortions on the image of the document 200, as discussed below, and initiating correction or rectification of the distorted portions of the image based on an intuitive or interactive image enhancement method, process, scheme or implementation discussed herein. Accordingly, the intuitive image enhancement process may be implemented in conjunction with the geometric correction device 302 to enhance quality of the image of the document 200.

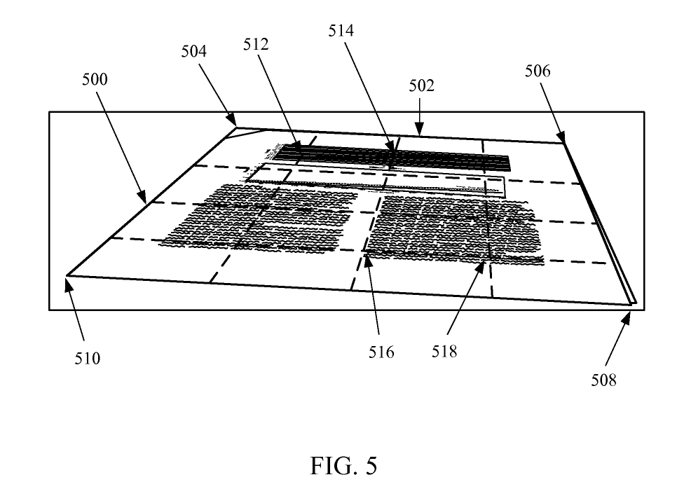

The geometric correction device 302 may be configured to detect edges of the captured image and to apply a transformation process to the detected edges of the captured image. In some aspects of the disclosure, the transformation process is a Hough Transform and/or Random Sample Consensus (RANSAC). This transformation process can be used to detect boundaries, illustrated as edges 500, 502 of FIG. 5, of the captured image. In some aspects, the captured image may further be annotated with sub-corners 516, 518 and sub-boundaries 512, 514 of FIG. 5. Different parameters of the captured image can be used for the purpose of rectification or quality enhancement. For example, edges 500, 502 of the document, page layout and textual structure provide clues to rectify the perspective distortion. The transformation process can be used to detect the boundaries, including edges 500, 502 of the captured image. From the edges 500 and 502 (as well as edges not designated with reference numbers), for example, the four corners of the document 504, 506, 508 and 510 can be located.

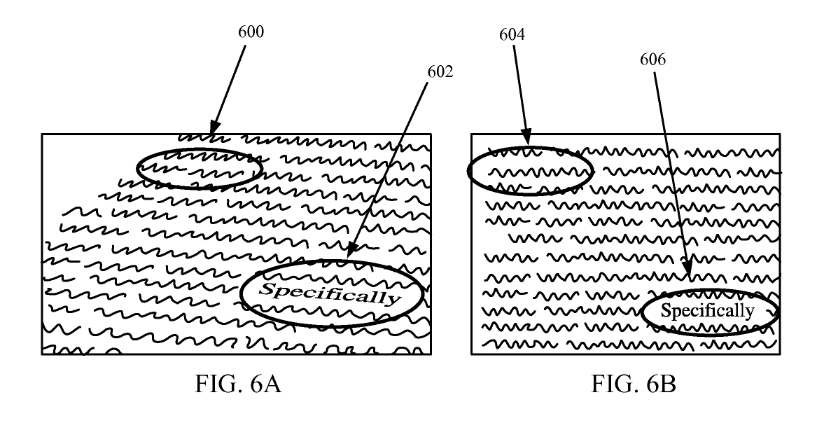

Some forms of geometric distortion, for example, perspective distortion, may be reduced based on a mapping implementation. The mapping implementation, e.g., computing a homography, using the boundary and edge information obtained to transform the captured image may be implemented to reduce perspective distortion as illustrated in FIGS. 6A and 6B. In FIG. 6A, the image suffers from perspective distortion as shown by the slanted character strings 600 and 602. FIG. 6B illustrates the image after reduction or rectification of perspective distortion by the geometric correction device 302. In this image the slanted character strings 600 and 602 are transformed to straight character strings 604 and 606 as illustrated in FIG. 6B.

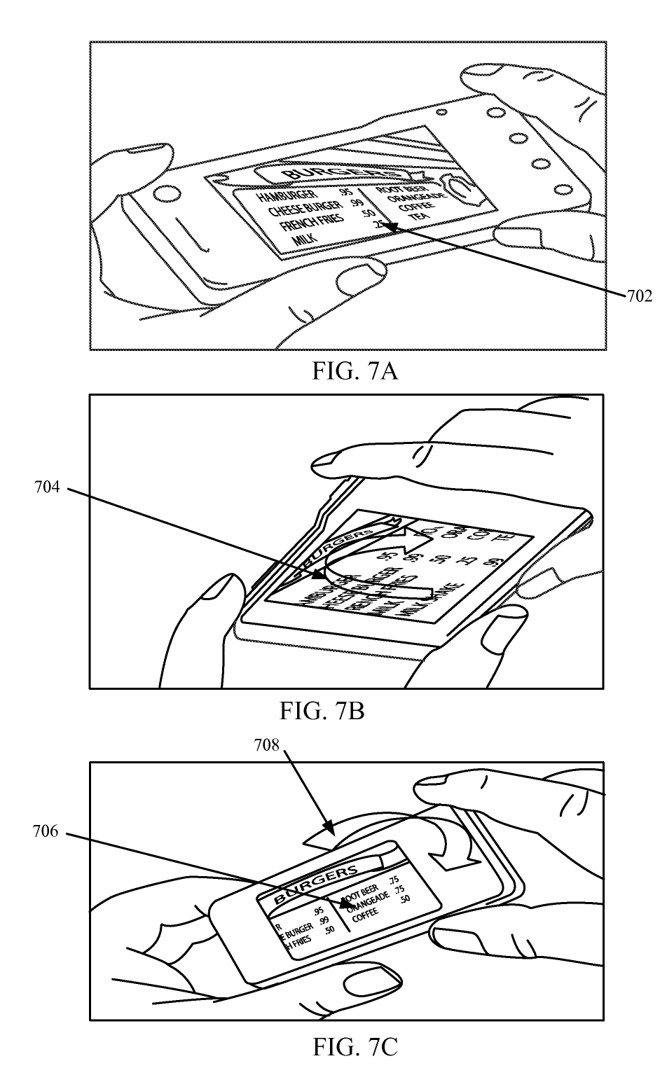

Rather than extracting the boundaries (as illustrated in FIG. 5) or in combination with extracting the boundaries, degradations can be reduced based on a user interaction as illustrated in FIGS. 7A, 7B and 7C. In some aspects of the disclosure, the user can be instructed to rotate the imaging device to capture the image at a different angle, for example, in order to reduce degradations such as perspective distortion. For example, a user can update the camera input manually or interactively such that boundaries can be located by touching a screen of the camera or rotating the camera. FIGS. 7A, 7B and 7C illustrate an exemplary interactive process for reducing, rectifying or correcting perspective distortion interactively with a user according to some aspects of the disclosure. FIG. 7A illustrates a perspectively distorted image displayed on a user interface 110 of an imaging device of a camera or cell phone. The perspectively distorted image 702 can be processed according to some aspects of the disclosure to identify the perspective distortion, for example.

In some aspects, the camera can recognize when the image is not a frontal view, and an instruction or indication can be generated and forwarded to the user interface device to enhance quality of the image 702. The instruction or indication may be a textual or graphical in nature and may be displayed to the user as a preview image indicating the desired correction. For example, FIG. 7B illustrates an arrow 704, instructing the user to rotate the imaging device, in the direction of the arrow to reduce perspective distortion when recapturing the image. Gyro sensors may be associated with the imaging device to detect rotation of the device and the arrow 704 can be adjusted accordingly, in order to reduce or rectify the perspective distortion. FIG. 7C illustrates an example of an image 706 after a user rotated the imaging device in the direction of the arrow 704. In FIG. 7C, another arrow 708 requests additional rotation to further correct image distortion while recapturing the image. In some aspects of the disclosure, the generated instruction may include instructions to the user to enhance image quality by touching the screen of a touch screen imaging device.

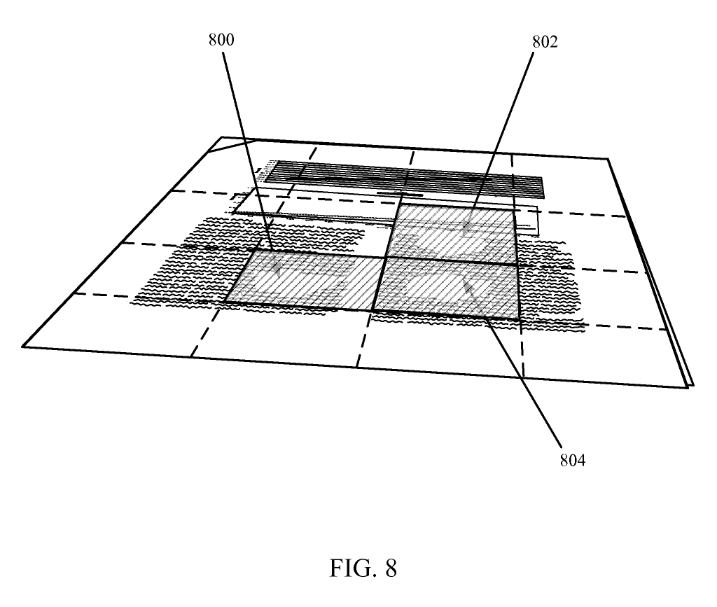

Even after the geometric, vignetting and radial distortions are corrected or reduced, some of the text in the captured image may not be recognizable due to photometric distortions as illustrated in positions 800, 802 and 804 of FIG. 8. The photometric correction device 304 may be configured to reduce the photometric distortions. In some aspects of the disclosure, the photometric correction device 304 can reduce or rectify the distortion by identifying or detecting the degradations on the image, as discussed below, and initiating correction or rectification of the distorted portions of the image based on the intuitive, interactive image enhancement or augmented reality method, scheme or implementation discussed herein. Therefore, the intuitive image enhancement process may be implemented in conjunction with the photometric correction device 304 to enhance quality of the image.

In some aspects of the disclosure, the photometric correction device 304 may be configured to receive a geometrically corrected image from the geometric correction device 302. Using the geometrically corrected image as a reference image, features such as scale-invariant feature transform (SIFT), speeded up robust features (SURF) and corner detection features can be extracted from the image. SIFT is an algorithm in computer vision to detect and describe local features in images and SURF is a robust image detector & descriptor.

The photometric correction device 304 may be configured to detect some degraded regions at positions 800, 802 and 804 (illustrated in FIG. 8) in the reference image, rectified image or geometrically corrected image. In some aspects, identifying the degraded regions or the degradation associated with the image includes computing at least one feature, including a sharpness, contrast, color, intensity, and/or an edge of the image. The computed feature(s) may be compared with at least one computed feature of a high quality document to determine the quality of the rectified image, for example. The photometric correction device 304 can distinguish between degraded regions that are due to the initial image being degraded and regions of the image that are degraded due to photometric distortions during the capture of the image. The photometric correction device 304 can make the distinction by implementing an estimated homography process. The photometric correction device 304 may adopt or compute sharpness measures, contrast, color/intensity histogram, edge features or a combination thereof and comparing these values with those of usual high-quality or non-degraded documents to detect the degraded regions of the reference image.

In some aspects of the disclosure, an input image associated with the reference image, may be fetched from the user interface device or preview module 110. The features from the fetched image can be extracted according to a process at the photometric correction device 304 and the geometric transformation between the fetched image and the reference image calculated. The reference image can be the foundation of the image upon which corrected portions of the image can be stitched or combined to form a desired image. Even after the photometric, geometric, vignetting and radial distortions are reduced, some of the text in the captured document 200 may suffer from degradations. Therefore, it is desirable to implement a process or system to further enhance quality of the captured image.

In some aspects of the disclosure, the photometric correction device 304, the geometric correction device 302 or the radial/vignetting distortion correction device 308 may be configured to generate an indication or an instruction for enhancing image quality. In some aspects of the disclosure, the instructions and/or indications may be generated by a processor (not shown) associated with the image processor 106. The processor may be incorporated in the image processor 106 or may be independent but coupled to the image processor 106. These instructions or indications may be generated after the degraded portions of the image are identified by the photometric correction device 304, the geometric correction device 302 or the radial/vignetting distortion correction device 308. In some aspects of the disclosure, the instructions or indications can be generated independently at the photometric correction device 304, the geometric correction device 302 or the radial/vignetting distortion correction device 308.

In some aspects of the disclosure, the instructions or indications can be generated collaboratively between the photometric correction device 304, the geometric correction device 302 or the radial/vignetting distortion correction device 308. For example, the degraded portions can be identified at one device and forwarded to a second device where the instructions or indications are collaboratively generated. In some aspects, the instructions or indications can be generated at one device and forwarded to another device where the instructions or indications are collaboratively processed. The instructions can be forwarded or transmitted to a user interface device 110 where the instructions or indications can be displayed to a user. The instructions and/or indications can be forwarded to the user interface device 110 by the photometric correction device 304, the geometric correction device 302, the radial/vignetting distortion correction device 308, the processor (not shown) or a combination thereof. The instructions and/or indications may highlight regions of the image that are distorted or degraded and/or may instruct the user or guide the user to make adjustments when recapturing the image or portions of the image.

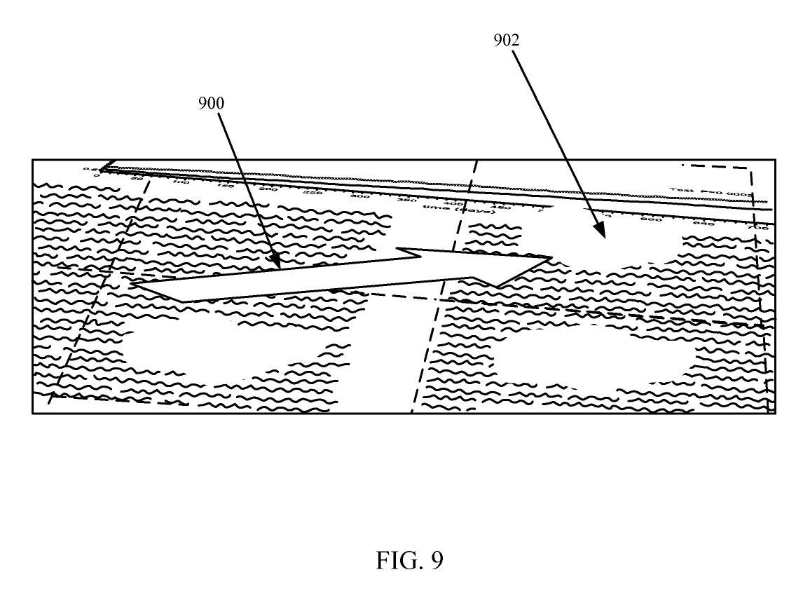

In some aspects of the disclosure, an indication 900 (illustrated in FIG. 9) of the position of a degraded region 902 may be generated by the photometric correction device 304 or any independent processor incorporated in the image processor or external to the image processor 106. The degraded image and the indication 900 can be displayed at a user interface device 110 for viewing by the user. In some aspects of the disclosure, the indication 900 of the degraded region 902 may be displayed in conjunction with instructions to guide the user to recapture the image in order to reduce or rectify degradations of the image. The user can be informed or instructed of the degraded regions of the image on the user interface device 110. The instructions or indications to a user may include overlaying an arrow or other indication 900 on the preview image, as illustrated in FIG. 9, which indicates the photometrically degraded regions to the user so that the user can correct them. The user may be instructed to correct the photometrically degraded regions by focusing on the indicated degraded region 902 when recapturing the image, for example.

After the user corrects the image, the image stitching device 306 may receive the recaptured image and the reference image and stitch or combine them to generate a desired image. In some implementations, the process can be repeated such that the recaptured image is fetched from the preview module or user interface device and mapped, and rectified regions stitched to the reference image, until a desired quality enhancement is obtained. The memory 108 may be configured to save the stitched images and the wireless interface 104 or wired interface (not shown) may be configured to transmit the stitched images over a network.

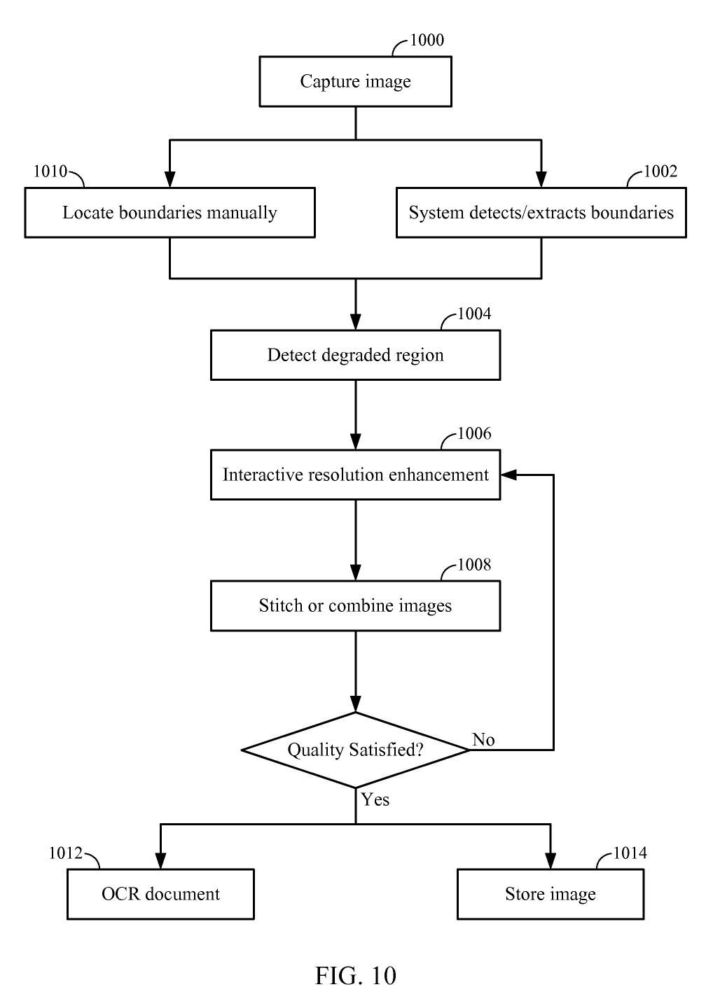

FIG. 10 illustrates an exemplary flowchart of a portable electronic device image acquisition method. The process can be implemented in the portable electronic device 100 of FIG. 1. The process starts at block 1000 where an image of a document, for example, may be captured by the imaging device. The imaging device may be a camera. After the image has been captured, the boundaries of the image are detected. In on configuration, the boundary detection may be either user detected or system detected. System detection of the boundaries occurs at block 1002. Such boundary extraction/detection processing may occur as described with respect to FIG. 5. After the system boundary detection, the system also estimates the camera position and viewing direction based on the detected boundaries. If the boundary is not rectangular, the document can then be transformed/rectified to obtain a frontal view.

Rather than having the system extract the boundaries, the user can extract the boundaries, at block 1010. For example, the user can draw or select the boundaries with a touch screen or cursor/pointing device. User boundary detection can also include rotating the image to obtain a frontal view, if desired (as described with respect to FIGS. 7A-C). Such manual boundary location could occur if the system is unable to recognize the boundaries, e.g., due to poor quality of the image.

At block 1004, degraded regions of the image are detected as illustrated with respect to FIG. 8. The process continues to block 1006 where an interactive image enhancement or interactive resolution enhancement process can be implemented to rectify degraded regions of the captured image as illustrated in FIGS. 8 and 9. That is, the video/preview mode of the image capture device can be enabled to permit interactive enhancing of the image. The system can indicate to the user in the displayed preview which portions of the document should be re-captured due to those regions being significantly degraded. This processing can be repeated if additional portions are degraded and should be recaptured.

At block 1008, at least portions of the enhanced image (e.g., any newly captured images) are stitched into the reference image to update the degraded regions and thus create an higher quality image. The orientation of the images from preview mode can be compared to the reference image to thus ensure a high quality image results from the stitching process. Although FIG. 10 shows blocks 1006 and 1008 being implemented sequentially, in some aspects, the processes at block 1006 and at block 1008 may be executed repeatedly until the stitched image quality is satisfactory. At block 1012, the rectified image can be subjected to optical character recognition (OCR). Alternatively, or in addition, the rectified image can be stored in memory at block 1014. In some aspects, the rectified image or the OCR'ed image may be transmitted via a wireless interface to a network.

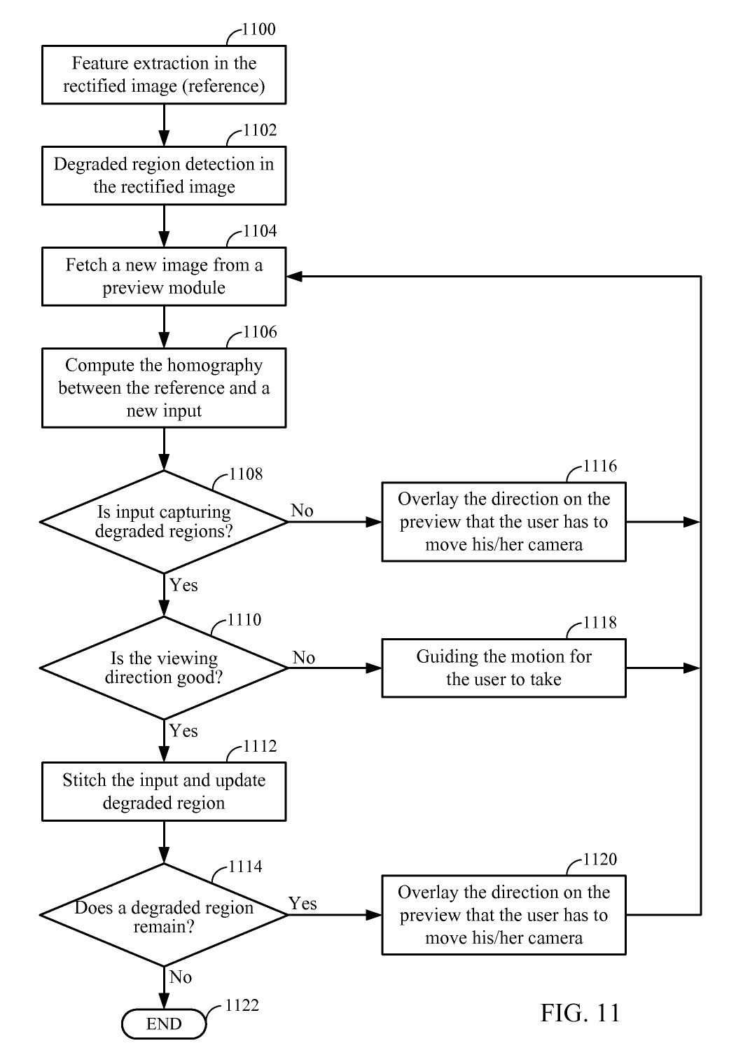

FIG. 11 illustrates a flow chart of the interactive resolution enhancement process implemented at block 1006 of FIG. 10. The interactive resolution enhancement process may be implemented in the image processor 106 of FIGS. 1 and 3. At block 1100, using the captured image of a document corrected for geometric distortions as a rectified (i.e., reference) image, processes such as SIFT, and SURF extract edge, corner, and other features from the reference image. At block 1102, the degraded regions in the rectified or geometrically corrected (reference) image are detected, as discussed above. At block 1104, a new or existing preview image of the document may be fetched from a user interface device or preview module. The new preview image may a recaptured image of the degraded regions of the reference image, for example when the quality is too low for rehabilitation. At block 1106, the geometric transformation between the fetched image and the reference image can be calculated.

At block 1108, it is determined whether the input image is degraded prior to being captured by an imaging device. If the degraded regions associated with the captured image are not due to an initially degraded image, then instructions for correcting the degraded regions are generated at block 1116, as illustrated with reference to FIG. 9. The instructions are then displayed to a user at block 1104 instructing the user to recapture the image based on the instructions. The instructions may include overlaying directions on the preview image, instructing the user to move or focus the imaging device on the degraded regions when fetching a new image or to adjust the angle of the camera, for example.

If the degraded regions are due to an initially degraded image then the process continues to block 1110 where a determination of whether the viewing direction of the imaging device was adequate. This determination may be based on applying a transformation process based on an estimate between the features of the rectified image and a previous image, for example. If it is determined that the viewing direction was adequate then the process continues to block 1112 where at least portions of the image fetched from the preview are stitched to the reference image to update the degraded regions. If it is determined at block 1110 that the viewing direction of the imaging device was inadequate then instructions are generated at block 1118 to guide the user to adjust the viewing angle of the imaging device or to guide the motion of the user to recapture the image (as illustrated with reference to FIGS. 7A-C), and the process then proceeds back to block 1104. At block 1114, it is determined whether any degraded region remains after the process at block 1112. If a degraded region remains, instructions are generated at block 1120 to guide the user during recapture of the image and the process returns to block 1104. Otherwise, the process ends at block 1122, and the flow returns to block 1008 of FIG. 10.

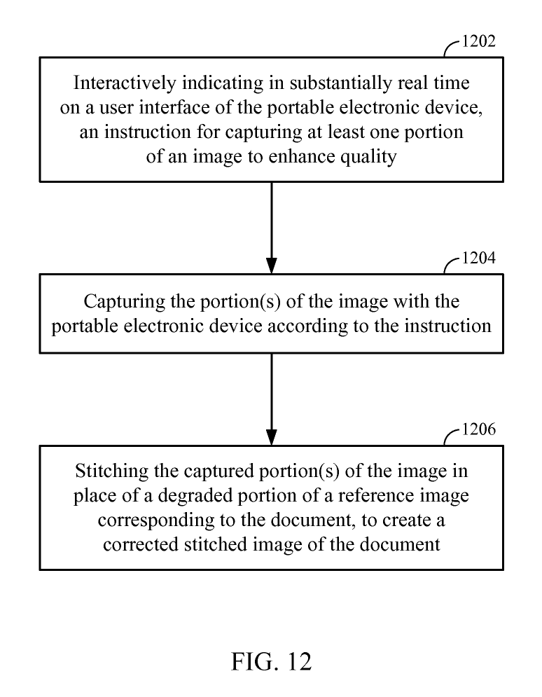

FIG. 12 illustrates a method of processing a captured image on a portable electronic device according to an aspect of the disclosure. The method starts at block 1202 by interactively indicating in substantially real time on a user interface of the portable electronic device, an instruction for capturing at least one portion of an image to enhance quality. The indication may be in response to identifying degradation associated with the at least one portion of the image. The method continues to block 1204 where the at least one portion of the image with the portable electronic device according to the instruction is captured. The method starts at block 1206 by stitching the at least one captured portion of the image in place of a degraded portion of a reference image corresponding to the document, to create a corrected stitched image of the document.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine or computer readable medium tangibly embodying instructions may be used in implementing the methodologies described herein. For example, software code may be stored in a memory and executed by a processor. When executed by the processor, the executing software code generates the operational environment that implements the various methodologies and functionalities of the different aspects of the teachings presented herein. Memory may be implemented within the processor or external to the processor. As used herein, the term “memory” refers to any type of long term, short term, volatile, nonvolatile, or other memory and is not to be limited to any particular type of memory or number of memories, or type of media upon which memory is stored.

The machine or computer readable medium that stores the software code defining the methodologies and functions described herein includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. As used herein, disk and/or disc includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media. The phrases “computer readable media” and “storage media” do not refer to transitory propagating signals.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps. Herein, claim elements of the form “at least one of A, B, and C” cover implementations with at least one A and/or at least one B and/or at least one C, as well as combinations of A, B, and C (e.g., AB, 2A2C, ABC, etc.)

What is claimed is:

1. A method of scanning an image of a document with a portable electronic device, comprising:
interactively indicating in substantially real time on a user interface of the portable electronic device, an instruction for capturing at least one portion of the image to enhance quality, in response to identifying degradation associated with the at least one portion of the image;
capturing the at least one portion of the image with the portable electronic device according to the instruction; and
stitching the at least one captured portion of the image in place of a degraded portion of a reference image corresponding to the document, to create a corrected stitched image of the document.

2. The method of claim 1, further comprising at least one of wirelessly transmitting the corrected stitched image of the document and storing the corrected stitched image of the document.

3. The method of claim 1, further comprising applying optical character recognition to the corrected stitched image.

4. The method of claim 1, in which identifying the degradation associated with the at least one portion of the image is based on at least one of geometric correction features, photometric correction features, radial correction features, and vignetting correction features.

5. The method of claim 1, further comprising repeating the interactively indicating, capturing and stitching to enhance quality of the corrected stitched image of the document.

6. The method of claim 1, in which identifying the degradation associated with the at least one portion of the image comprises an estimated homography process.

7. The method of claim 1, in which identifying the degradation associated with the at least one portion of the image further comprises:
computing at least one feature, comprising: at least one of sharpness, contrast, color, intensity, and an edge of the image; and
comparing the at least one computed feature with at least one computed feature of a high quality document.

8. The method of claim 1, further comprising detecting edges of the image and applying a transformation process based on the detected edges.

9. The method of claim 1, further comprising manually updating input of the image to facilitate locating edges of the image.

10. An apparatus for scanning an image of a document with a portable electronic device, comprising:
means for interactively indicating in substantially real time on a user interface of the portable electronic device, an instruction for capturing at least one portion of the image to enhance quality, in response to identifying degradation associated with the at least one portion of the image;
means for capturing the at least one portion of the image with the portable electronic device according to the instruction; and
means for stitching the at least one captured portion of the image in place of a degraded portion of a reference image corresponding to the document, to create a corrected stitched image of the document.

11. An apparatus for scanning an image of a document with a portable electronic device, comprising:
a memory; and
at least one processor coupled to the memory and configured:
to interactively indicate in substantially real time on a user interface of the portable electronic device, an instruction for capturing at least one portion of the image to enhance quality, in response to identifying degradation associated with the at least one portion of the image;
to capture the at least one portion of the image with the portable electronic device according to the instruction; and
to stitch the at least one captured portion of the image in place of a degraded portion of a reference image corresponding to the document, to create a corrected stitched image of the document.

12. The apparatus of claim 11, in which the at least one processor is further configured to at least one of wirelessly transmit the corrected stitched image of the document and store the corrected stitched image of the document.

13. The apparatus of claim 11, in which the at least one processor is further configured to apply optical character recognition to the corrected stitched image.

14. The apparatus of claim 11, in which the at least one processor is further configured to identify the degradation associated with the at least one portion of the image based on at least one of geometric correction features, photometric correction features, radial correction features, and vignetting correction features.

15. The apparatus of claim 11, in which the at least one processor is further configured to repeat the interactively indicating, capturing and stitching to enhance quality of the corrected stitched image of the document.

16. The apparatus of claim 11, in which the at least one processor is further configured to identify the degradation associated with the at least one portion of the image by an estimated homography process.

17. The apparatus of claim 11, in which the at least one processor is further configured to identify the degradation associated with the at least one portion of the image by:
computing at least one feature, comprising: at least one of sharpness, contrast, color, intensity, and an edge of the image; and
comparing the at least one computed feature with at least one computed feature of a high quality document.

18. The apparatus of claim 11, in which the at least one processor is further configured to detect edges of the image and apply a transformation process based on the detected edges.

19. The apparatus of claim 11, in which the at least one processor is further configured to manually update input of the image to facilitate locating edges of the image.

20. A computer program product for scanning an image of a document with a portable electronic device, comprising:
a computer-readable medium having program code recorded thereon, the program code comprising:
program code to interactively indicate in substantially real time on a user interface of the portable electronic device, an instruction for capturing at least one portion of the image to enhance quality, in response to identifying degradation associated with the at least one portion of the image;
program code to capture the at least one portion of the image with the portable electronic device according to the instruction; and
program code to stitch the at least one captured portion of the image in place of a degraded portion of a reference image corresponding to the document, to create a corrected stitched image of the document.
